(19) United States
(12) Patent Application Publication
(10) Pub. No.: US 2019/0124659 A1
(43) Pub. Date: Apr. 25, 2019

(54) NETWORK COMMUNICATION FREQUENCY ADJUSTMENT

(71) Applicant: Google LLC, Mountain View, CA (US)

(72) Inventor: Jibing Wang, Saratoga, CA (US)

(21) Appl. No.: 15/789,064

(22) Filed: Oct. 20, 2017

(51) Int. Cl. H04W 72/04; H04W 76/02; H04W 76/06; H04W 76/04

(52) U.S. Cl. CPC H04W 72/0453; H04W 72/042; H04W 76/02; H04W 16/14; H04W 76/027; H04W 76/045; H04W 76/06

(57) ABSTRACT

Methods, systems, and apparatus, including computer programs encoded on a computer storage medium, for adjusting network communication frequencies are disclosed. In one aspect, a method includes the actions of receiving, by a long-term evolution (LTE) base station, an instruction to communicate with a client device over a first frequency. The actions further include transmitting, by the LTE base station and to the client device over a second, different frequency, an instruction to communicate with the LTE base station over the first frequency after a particular period of time. The actions further include, after the particular period of time has elapsed, receiving, by the LTE base station and from the client device over the first frequency, a request to establish a communication channel over the first frequency. The actions further include establishing, by the LTE base station, a communication channel with the client device over the first frequency.

### TECHNICAL FIELD

This specification generally relates to data communications.

### BACKGROUND

A data network is a digital telecommunications network which allows nodes to share resources. Networked computing devices may exchange data with each other using a data link. The connections between nodes may be established using either cable media or wireless media.

### SUMMARY

The citizens broadband radio service (CBRS) frequency band may include an underutilized portion of spectrum that wireless services providers may be able to utilize to improve bandwidth for the growing number of wireless client devices using their networks. Because the CBRS frequency band has other users who may have higher priority use (e.g., higher bidding users) of the frequency band than the wireless service provider, a spectrum controller may be necessary to manage use of the CBRS frequency band to prevent interference. The spectrum controller may notify the base stations of wireless services providers when the base stations should not be transmitting on the CBRS frequency band. In some implementations, the base stations may switch to a different frequency band when instructed by the spectrum controller. When this frequency switch occurs, the client devices may lose connectivity with the base stations. Each client device may have to blindly search different frequency bands to identify the frequency band to which the base stations switched. While this searching occurs, the client device is disconnected from the network which may hurt the user experience by dropping calls, buffering videos, and delaying downloads.

To avoid requiring client devices to blindly search for the new frequency band, the base station may transmit a message to the client devices indicating the new frequency band and the time at which the base station will switch to the new frequency band. At the specified time, the client devices may switch from the previous frequency band to the new frequency band without having to search multiple frequency bands to identify the correct one. With the client device seamlessly connecting to the base station over a new frequency band, the user may not notice any drop in wireless network service. The user's calls may continue uninterrupted, videos may continue playing, and downloads may continue without delay.

According to an innovative aspect of the subject matter described in this application, a method for adjusting network communication frequencies includes the actions of receiving, by a long-term evolution (LTE) base station, an instruction to communicate with a client device over a first frequency; transmitting, by the LTE base station and to the client device over a second, different frequency, an instruction to communicate with the LTE base station over the first frequency after a particular period of time; after the particular period of time has elapsed, receiving, by the LTE base station and from the client device over the first frequency, a request to establish a communication channel over the first frequency; and establishing, by the LTE base station, a communication channel with the client device over the first frequency.

These and other implementations can each optionally include one or more of the following features. The action of transmitting, by the LTE base station and to the client device over a second, different frequency, an instruction to communicate with the LTE base station over the first frequency after a particular period of time includes transmitting, by the LTE base station and to the client device over the second, different frequency, a radio resource control (RRC) release message that instructs the client device to disconnect from the LTE base station and the particular period of time after which the LTE base station will be available to establish a communication channel over the first frequency. The action of transmitting, by the LTE base station and to the client device over a second, different frequency, an instruction to communicate with the LTE base station over the first frequency after a particular period of time includes transmitting, by the LTE base station and to the client device over the second, different frequency, a system information block (SIB) message that includes the particular period of time after which the LTE base station will be available to establish a communication channel over the first frequency.

The actions further include receiving, by the LTE base station and from the client device over the second, different frequency, an RRC connection request. The action of transmitting, by the LTE base station and to the client device over a second, different frequency, an instruction to communicate with the LTE base station over the first frequency after a particular period of time includes transmitting, by the LTE base station and to the client device over the second, different frequency, an RRC connection reject message that indicates the particular period of time after which the LTE base station will be available to establish a communication channel over the first frequency. The action of transmitting, by the LTE base station and to the client device over a second, different frequency, an instruction to communicate with the LTE base station over the first frequency after a particular period of time includes transmitting, by the LTE base station and to the client device over the second, different frequency, an RRC connection reconfiguration message (i) that instructs the client device to establish a communication channel with a different LTE base station over the first frequency and (ii) that indicates the particular period of time after which the different LTE base station will be available to establish the communication channel over the first frequency.

The RRC connection reconfiguration message indicates an additional particular time period after which the LTE base station will be available to establish a communication channel over the first frequency. The action of transmitting, by the LTE base station and to the client device over a second, different frequency, an instruction to communicate with the LTE base station over the first frequency after a particular period of time includes transmitting, by the LTE base station and to the client device over the second, different frequency, an RRC connection reconfiguration message (i) that indicates that the LTE base station will remove the client device from the second component carrier and (ii) that indicates the particular period of time after which the different LTE base station will be available to establish a secondary component channel over the first frequency. The client device establishes the communication channel with the LTE base station over the first frequency without attempting to establish the communication channel with the LTE base station over other frequencies. The actions further include receiving, by the LTE base station, an instruction to cease communicating with the client device over the second, different frequency.

The action of transmitting, by the LTE base station and to the client device over a second, different frequency, an instruction to communicate with the LTE base station over the first frequency after a particular period of time includes, in response to receiving the instruction to cease communicating with the client device over the second, different frequency, transmitting the instruction to communicate with the LTE base station over the first frequency after the particular period of time. The action of transmitting, by the LTE base station and to the client device over a second, different frequency, an instruction to communicate with the LTE base station over the first frequency after a particular period of time includes, in response to receiving the instruction to communicate with the client device over the first frequency, transmitting the instruction to communicate with the LTE base station over the first frequency after the particular period of time.

Other embodiments of this aspect include corresponding systems, apparatus, and computer programs recorded on computer storage devices, each configured to perform the operations of the methods.

Particular embodiments of the subject matter described in this specification can be implemented so as to realize one or more of the following advantages. A wireless network system may take advantage of the CBRS frequency band without interfering with high priority users of the CBRS frequency band. More systems may take advantage of the CBRS frequency band which may not be heavily utilized. The wireless network system may be able to seamlessly switch to between using the CBRS frequency band and not using the CBRS frequency band such that the switching may be transparent to the user.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example system switching frequencies on a long-term evolution (LTE) network.

FIG. 2 is a flowchart of an example process for switching frequencies on an LTE network.

FIG. 3 is an example of a computing device and a mobile computing device.

Like reference numbers and designations in the various drawings indicate like elements.

### DETAILED DESCRIPTION

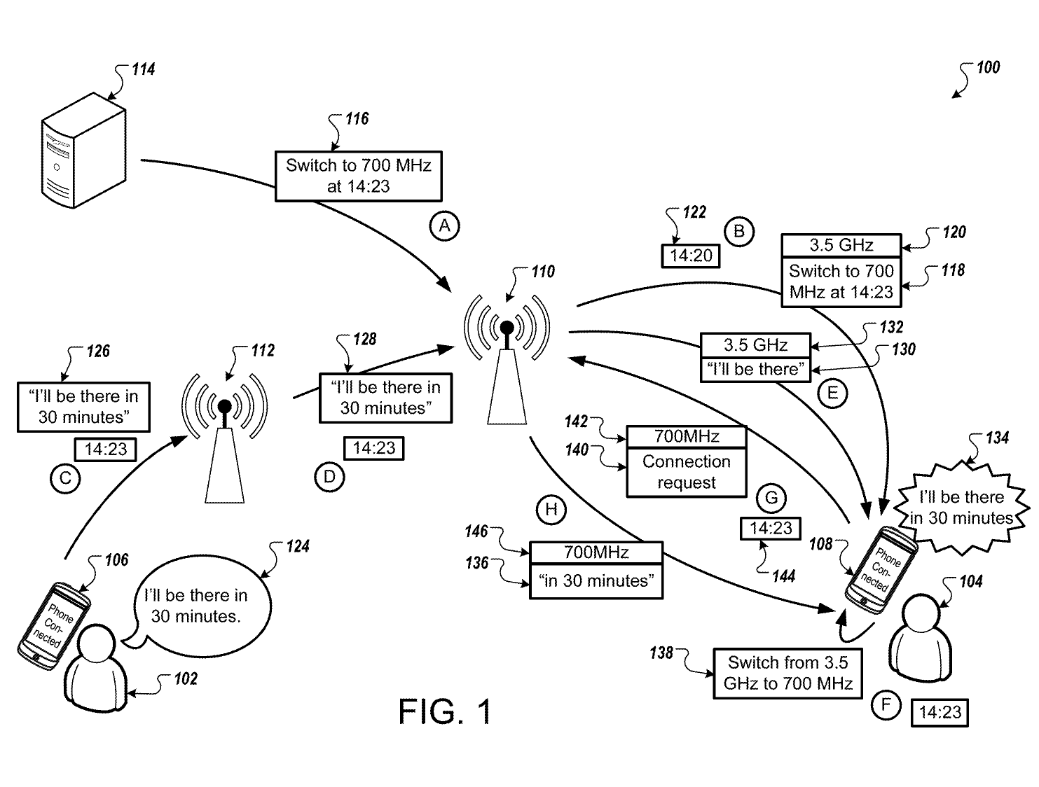

FIG. 1 is an example system 100 switching frequencies on an LTE network. Briefly, and as described in more detail below, the user 102 is using computing device 106 to communicate with user 104 who is using computing device 108. Computing device 106 and computing device 108 are communicating over an LTE network. During the phone call, computing device 108 switches from communicating over the LTE network using 3.5 GHz to 700 MHz. The frequency switch may not be noticeable to user 102 or user 104 and the phone conversation continues uninterrupted.

Base station 110 of the LTE network may be configured to communicate with computing devices through a number of different frequency channels. In some implementations, the base station 100 may change frequency channels in response to a request from the spectrum controller 114. The base station 110 may change frequency channels without notifying the computing device 108. In this instance, the computing device 108 will lose communication with the base station 110. The computing device 108 will have to search different frequency channels to locate the frequency channel that base station 110 switched to. While computing device 108 is searching for the proper frequency channel, the loss of communication may hurt the experience of user 104. For example, telephone calls may drop, downloads may be interrupted, videos may buffer, etc.

Using the technology described below, the base station 110 may communicate in advance with the computing device 108 as to the new frequency channel. This communication may indicate the new frequency channel and the time that the frequency channel change will happen. With this information, the base station 110 and the computing device 108 may seamlessly switch from communicating over one frequency channel to another frequency channel with virtually no delay. By decreasing the delay in changing frequency channels, the experience of user 104 is not compromised. The user's telephone calls continue without dropping, video play continuously, downloads continue, etc. In the absence of any graphical indication of the frequency channel change on the screen of the computing device 108, the user 104 may be unaware that the computing device 108 switched frequency channels.

In the example show in FIG. 1, computing device 106 and computing device 108 are connected to the LTE network that includes base station 110 and base station 112. Computing device 106 may wirelessly communicate with nearby base station 112, and computing device 108 may wirelessly communicate with nearby base station 110. The computing device 106 and computing device 108 may be any type of computing device that is configured to communicate of a wireless network such as an LTE network. For example, computing devices 106 and 108 may be a smart phone, a desktop computer, a laptop computer, a tablet, a smart watch, a smart speaker, a mobile hotspot, an internet connected appliance, or any similar type of computing device. Base station 110 may communicate with base station 110 through a wired or wireless connection.

Initially, either user 102 or user 104 may dial the telephone number for the other user. For example, user 102 may instruct the computing device 106 to call user 104. The computing device 106, which is connected to the LTE network through base station 112, connects with computing device 108, which belongs to user 104. The computing device 108 may be connected to the LTE network through base station 110. The network of base station 110 may not be the same as the network of base station 112. For example, base station 110 and base station 112 may be part of different networks belonging to different wireless network service providers.

While the users 102 and 104 are talking on the telephone the frequency channel for base station 110 and computing device 108 may change. This change may be seamless to user 104 and user 108 as the telephone call remains connected, and the base stations 110 and 112 transmit and receive voice data with minimal delay. Either before or during the phone call and in stage A, the spectrum controller 114 transmits a request 116 to base station 110 to switch to the 700 MHz frequency channel at the time of 14:23. The request 116 may include an instruction to stop using a particular frequency channel at a particular time, either with or without the request to switch to a particular frequency channel.

The spectrum controller 114 may manage use of a particular frequency band. For example, the spectrum controller 114 may mange use of the citizens broadband radio service (CBRS) frequency band at 3.5 GHz. The CBRS frequency band may have a number of different users, where each user has a different priority level. A user with a lower priority may have to yield usage of the CBRS frequency band to a user with a high priority. The spectrum controller 114 may identify usage requests for the CBRS frequency band and issue instructions to ensure that the user with the highest priority has use of the CBRS frequency band. As an example, a container shipping company may have highest priority of the CBRS frequency band by virtue of bidding more for use of the CBRS frequency band than other bidders. Wireless data networks may have lower priorities because they bid less than the container shipping company. If a container ship comes within range of base station 110, then the spectrum controller 114 may request that the base station 110 stop communicating on the CBRS frequency band while the container ship is within range of the base station 110. This prevents interference between the wireless data network and the container ship. As the container ship leaves the range of the base station 110, the spectrum controller 114 may notify the base station 110 that it may resume communicating on the CBRS frequency band.

At stage B, the base station 110 transmits instruction 118 to computing device 108. The instruction 118 may include a request to transmit on a particular frequency channel at a particular time and/or to stop transmitting on a particular frequency channel at the particular time. For example, the instruction 118 may indicate that the base station 110 will begin transmitting at 700 MHz at 14:23. The base station 110 may transmit the instruction 118 to all computing devices that are connected to the base station 110. The base station 110 may transmit instruction 118 over frequency channel 120, for example, 3.5 GHz. The base station 110 may transmit the instruction 118 at a time 122 that is before the requested frequency channel switch. For example, the base station may transmit the instruction 118 at 14:20, which is three minutes before the frequency channel switch.

During stage C, the user 102 and the user 104 may be in the middle of their telephone conversation. The user may speak utterance 124 by saying that “I'll be there in 30 minutes.” The microphone of computing device 106 detects the utterance 124 and processes it using the audio subsystem of the computing device 106. The computing device 106 transmits audio data 126 that correspond to the utterance 124 to the base station 112. The computing device 106 may transmit the audio data 126 at approximately the same time as the base station 110 switches frequency channels. For example, the computing device 106 may transmit the audio data 126 at 14:23 or slightly before (e.g., four hundred milliseconds).

At stage D, the base station 112 transmits the audio data 128 to the base station 110. The base station 112 may transmit the audio data 128 over a wired connection or a wireless channel. The base station 112 may transmit the audio data 128 soon after the base station 112 receives the audio data 128 from the computing device 106. For example, the base station 112 may transmit the audio data 128 to base station 110 at 14:23 or slightly before (e.g., two hundred milliseconds).

The base station 110 may receive the audio data 128 only a short time (e.g., one hundred milliseconds) before the specified switching time of the frequency. In this example and in stage E, the base station 110 transmits an initial portion 130 of the audio data 128 over the frequency channel 132 that the base station 110 was originally transmitting (e.g., 3.5 GHz). The initial portion 130 of the audio data 128 may include the audio data corresponding to “I'll be there.” In order to avoid a delay in transmitting the audio data 128, in order to switch to the frequency channel by the requested time, and in order to preserve the quality of the user experience, the base station 110 may transmit the initial portion 130 nearly immediately before switching the frequency channel.

The computing device 108 receives the initial portion 130 of the audio data and may begin to output audio 134 corresponding to the initial portion 130 of the audio data through the audio speaker of the computing device 108. The computing device 108 and the base station 110 may perform stages F, G, and H in a short period of time (e.g., two hundred milliseconds) that any delay between outputting audio corresponding to the initial portion 130 of the audio data and outputting audio corresponding to a remaining portion 136 of the audio data may be imperceptible to the user 104.

In stage F and at the time specified by instruction 118 (e.g., 14:23 or one hundred milliseconds before), the computing device 108 begins switching frequency channels. The computing device 108 may execute instruction 138 that indicates to switch from the 3.5 GHz frequency channel to the 700 MHz frequency channel. In stage G, the computing device 108 transmits a connection request 140 at over the new frequency channel 142 to the base station 110. The computing device 108 may transmit the request 140 almost right at the requested time 144 (e.g., 14:23).

In some implementations, in response to the connection request 140, and before stage H, the base station 110 may transmit an acknowledgement to the computing device 108 indicating that the base station 110 accepted the connection request 140. In stage H, the base station 110 transmits the remaining portion 136 of the audio data over the new frequency band 146. The base station 110 may transmit, to the computing device 108 the remaining portion 136 of the audio data quickly after (e.g., one hundred milliseconds) receiving the connection request 140.

The computing device 108 may output the audio corresponding to the remaining portion 136 of the audio data through the audio speaker. Because the computing device 108 reconnected to the base station 110 over a different frequency channel, there may be a slight delay between outputting audio corresponding to the initial portion 130 and outputting audio corresponding to the remaining portion 136. This delay may be imperceptible to the user 104 or may sound like the user 106 paused between speaking the utterance corresponding to the initial portion 130 and the utterance corresponding to the remaining portion 146.

In some implementations, the spectrum controller 114 may transmit an indication that the base station 110 may return to the 3.5 GHz frequency band. The base station 110 may repeat stages B and G with and instruction and a connection request to return to the 3.5 GHz frequency band. Similar to the switch to the 700 MHz frequency band, this switch may be imperceptible to the user 104.

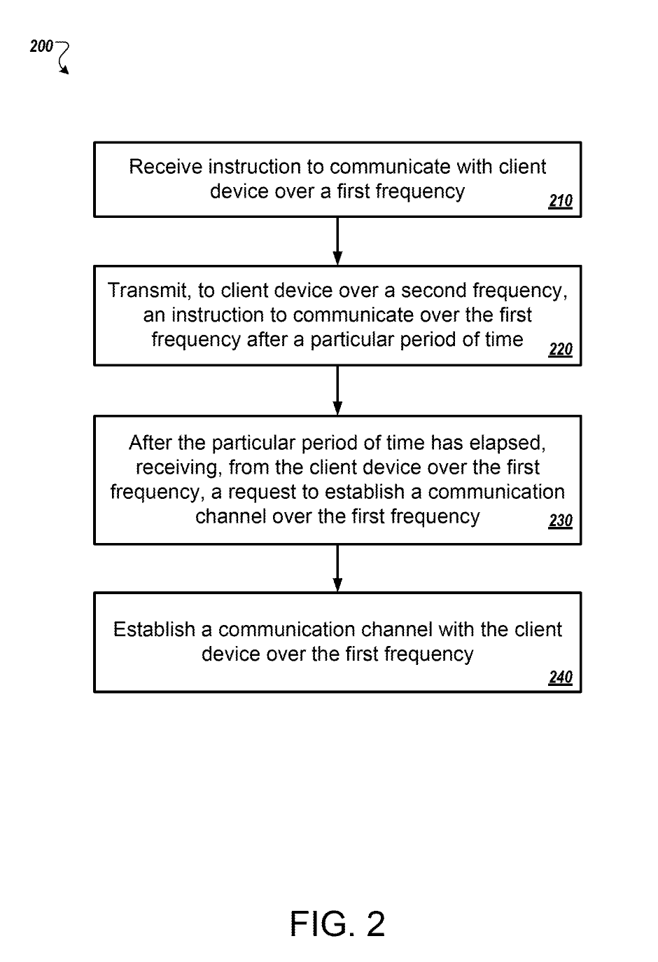

FIG. 2 illustrates an example process 200 for switching frequencies on an LTE network. In general, the process 200 seamlessly switches the frequency channel used by a base station in response to a request from a spectrum controller. The process 200 notifies the computing devices that are connected to the base station to switch to a different frequency channel at a particular time. The process 200 will be described as being performed by a computer system comprising one or more computers, for example, the system 100 or the base station 110 of FIG. 1.

The system receives an instruction to communicate with a client device over a first frequency (210). In some implementations, the system is an LTE base station that received the instruction from a spectrum controller. The spectrum controller may identify a higher priority user than the system and request that the system communicate over the first frequency. In some implementations, the first frequency is a typical LTE frequency such as 700 MHz. In some implementations, the system requests instructions from the spectrum controller at periodic intervals. For example, the system may request instructions every minute.

The system transmits, to the client device over a second, different frequency, an instruction to communicate with the system over the first frequency after a particular period of time (220). In some implementations, the system may transmit the instruction to communicate with the system over the first frequency in response to receiving the instruction to communicate with the client device over the first frequency. In some implementations, the second, different frequency is a CBRS frequency band, such as 3.5 GHz.

In some implementations, the system receives an instruction to cease communicating with the client device over the second, different frequency. In this instance, the system transmits, to the client device, the instruction to communicate over the first frequency after the particular period of time in response to receiving the instruction to cease communicating with the client device over the second, different frequency.

After the particular period of time has elapsed, the system receives, from the client device over the first frequency, a request to establish a communication channel over the first frequency (230). For example, the request may be a request to begin communicating over a communication channel of 700 MHz. In some implementations, the client device may not send multiple requests over different frequencies to discover the correct frequency that the system is communicating over. In other words, the client device may not be required to scan the frequencies of different communication channels to discover the one that the system is now using to transmit.

The system establishes a communication channel with the client device over the first frequency (240). For example, the system and the client device may begin exchanging data using the 700 MHz communication channel. In some implementations, the instruction to communicate with a client device over a first frequency, may include a time period to cease communicating with the first frequency. In this instance, the system and the client device may communicate over the first frequency only for the specified period of time, such as three hours. This time period may correspond to the period of time where the system determines that a user with a higher priority than the system is using the first frequency.

The system may use different techniques to transmit the instructions to communicate with the system over the first frequency after a particular period of time. In some implementations, the system may transmit a radio resource control (RRC) release message that instructs the client device to disconnect from the system. The RRC release message may include a time period after which the client device should attempt to reconnect to the system at the first frequency. For example, instruction message 118 of FIG. 1 may be an RRC release message. Instruction message 118 may instruct the client device to transition idle mode using idle mode mobility control info at 14:23. The instruction message 118 may instruct the client device to connect to the system using the 700 MHz communication channel at 14:23 or shortly after 14:23, such as two hundred milliseconds after 14:23. In some implementations, the system may transmit, in one RRC message, an instruction to transition to idle mode at a particular time and, in another RRC message, an instruction to connect at the second different frequency after the particular time or at a specified time.

In some implementations, the system may transmit a system information block (SIB) message to the client device. The SIB message may indicate a time when the system will begin transmitting at the second, different frequency. For example, instruction message 118 of FIG. 1 may be a SIB message that includes data indicating that the system will switch to 700 MHz at 14:23. The client device receives the SIB message and transmits a connection request at the particular time.

In some implementations, the system may use RRC messages in a different way than described above. The system may receive an RRC connection message from a client device that is attempting to connect to the system. The system may receive the RRC connection message before switching the frequency of the connection channel to the second, different frequency. The system may reject the RRC connection message and transmit, to the client device, an RRC connection reject message. The RRC connection reject message may include data indicating that the system will switch to the second, different frequency at the particular time, for example, 700 MHz at 14:23. The client device may then connect to the system at the particular time over the second, different frequency.

In some implementations, the system may transmit a request to the client device to connect to a different system, such as a different base station. The request may be an RRC connection reconfiguration message. The RRC connection reconfiguration message may instruct the client device to connect to a different LTE base station and indicate that the system will operate at the second, different frequency at a particular time. In some implementations, the RRC connection reconfiguration message may indicate a time period for the client device to reconnect to the system using the second, different frequency.

For example, the system may transmit to the client device a handover message, e.g., an RRC connection reconfiguration message with mobility control info. The handover message may include data indicating the second, different frequency and the particular time for the client device to communicate with the system. The client device may not connect to the other system. Instead, the client device may just connect to the system over the second, different frequency at the particular time.

As another example, the handover message, e.g., an RRC connection reconfiguration message with mobility control info, may identify the other system or base station for the client device to temporarily connect to. The handover message may include a request for the client device to reconnect to the system over the second, different frequency at the particular time. The client device may connect to the different system using the first frequency and then connect to the system over the second, different frequency at the particular time. In instances where the different system is switching its frequency, the handover message may include an instruction to connect to the different system over the second, different frequency.

In some implementations, the system may change secondary component carriers in response to the instructions from the spectrum controller. The system may remove the client device from the second component carrier using an RRC connection reconfiguration message. The RRC connection reconfiguration message may indicate new second component channel and the particular time at new second component channel will be available.

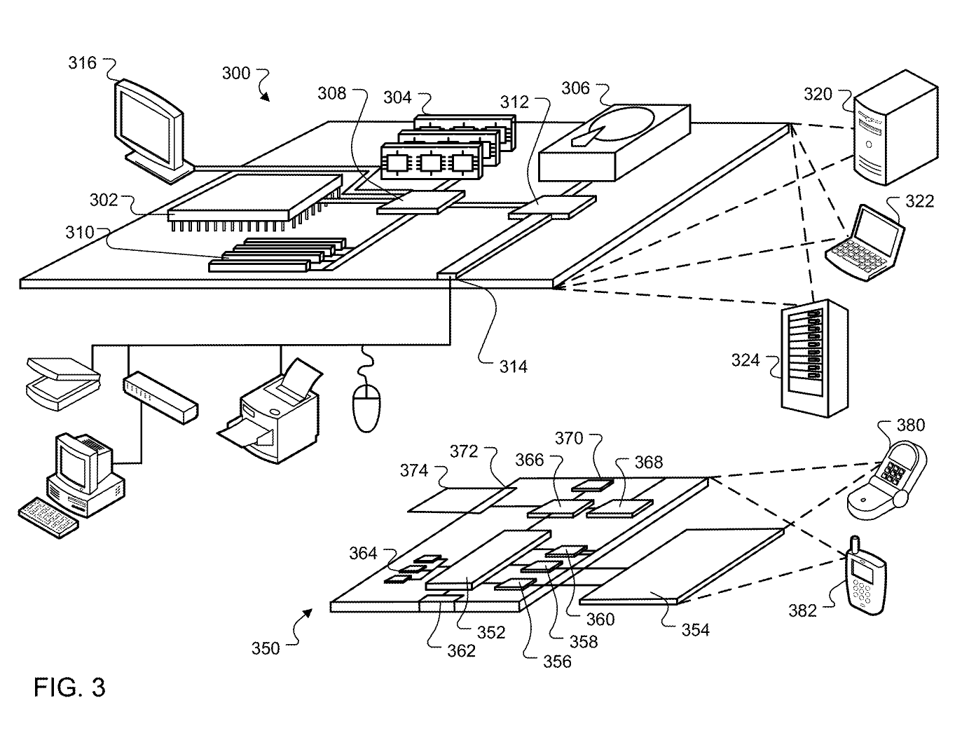

FIG. 3 shows an example of a computing device 300 and a mobile computing device 350 that can be used to implement the techniques described here. The computing device 300 is intended to represent various forms of digital computers, such as laptops, desktops, workstations, personal digital assistants, servers, blade servers, mainframes, and other appropriate computers. The mobile computing device 350 is intended to represent various forms of mobile devices, such as personal digital assistants, cellular telephones, smart-phones, wireless (e.g., Bluetooth) headsets, hearing aid, smart watches, smart glasses, activity trackers, and other similar computing devices. The components shown here, their connections and relationships, and their functions, are meant to be examples only, and are not meant to be limiting.

The computing device 300 includes a processor 302, a memory 304, a storage device 306, a high-speed interface 308 connecting to the memory 304 and multiple high-speed expansion ports 310, and a low-speed interface 312 connecting to a low-speed expansion port 314 and the storage device 306. Each of the processor 302, the memory 304, the storage device 306, the high-speed interface 308, the high-speed expansion ports 310, and the low-speed interface 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as a display 316 coupled to the high-speed interface 308. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 304 stores information within the computing device 300. In some implementations, the memory 304 is a volatile memory unit or units. In some implementations, the memory 304 is a non-volatile memory unit or units. The memory 304 may also be another form of computer-readable medium, such as a magnetic or optical disk.

The storage device 306 is capable of providing mass storage for the computing device 300. In some implementations, the storage device 306 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 302), perform one or more methods, such as those described above. The instructions can also be stored by one or more storage devices such as computer- or machine-readable mediums (for example, the memory 304, the storage device 306, or memory on the processor 302).

The high-speed interface 308 manages bandwidth-intensive operations for the computing device 300, while the low-speed interface 312 manages lower bandwidth-intensive operations. Such allocation of functions is an example only. In some implementations, the high-speed interface 308 is coupled to the memory 304, the display 316 (e.g., through a graphics processor or accelerator), and to the high-speed expansion ports 310, which may accept various expansion cards (not shown). In the implementation, the low-speed interface 312 is coupled to the storage device 306 and the low-speed expansion port 314. The low-speed expansion port 314, which may include various communication ports (e.g., USB, Bluetooth, Ethernet, wireless Ethernet) may be coupled to one or more input/output devices, such as a keyboard, a pointing device, a scanner, a microphone, speakers, or a networking device such as a switch or router, e.g., through a network adapter.

The computing device 300 may be implemented in a number of different forms, as shown in the figure. For example, it may be implemented as a standard server 320, or multiple times in a group of such servers. In addition, it may be implemented in a personal computer such as a laptop computer 322. It may also be implemented as part of a rack server system 324. Alternatively, components from the computing device 300 may be combined with other components in a mobile device (not shown), such as a mobile computing device 350. Each of such devices may contain one or more of the computing device 300 and the mobile computing device 350, and an entire system may be made up of multiple computing devices communicating with each other.

The mobile computing device 350 includes a processor 352, a memory 364, an input/output device such as a touch-enabled display 354, a communication interface 366, and a transceiver 368, among other components. The mobile computing device 350 may also be provided with a storage device, such as a micro-drive or other device, to provide additional storage. Each of the processor 352, the memory 364, the display 354, the communication interface 366, and the transceiver 368, are interconnected using various buses, and several of the components may be mounted on a common motherboard or in other manners as appropriate.

The processor 352 can execute instructions within the mobile computing device 350, including instructions stored in the memory 364. The processor 352 may be implemented as a chipset of chips that include separate and multiple analog and digital processors. The processor 352 may provide, for example, for coordination of the other components of the mobile computing device 350, such as control of user interfaces, applications run by the mobile computing device 350, and wireless communication by the mobile computing device 350.

The processor 352 may communicate with a user through a control interface 358 and a display interface 356 coupled to the display 354. The display 354 may be, for example, a TFT (Thin-Film-Transistor Liquid Crystal Display) display or an OLED (Organic Light Emitting Diode) display, or other appropriate display technology. The display interface 356 may comprise appropriate circuitry for driving the display 354 to present graphical and other information to a user. The control interface 358 may receive commands from a user and convert them for submission to the processor 352. In addition, an external interface 362 may provide communication with the processor 352, so as to enable near area communication of the mobile computing device 350 with other devices. The external interface 362 may provide, for example, for wired communication in some implementations, or for wireless communication in other implementations, and multiple interfaces may also be used.

The memory 364 stores information within the mobile computing device 350. The memory 364 can be implemented as one or more of a computer-readable medium or media, a volatile memory unit or units, or a non-volatile memory unit or units. An expansion memory 374 may also be provided and connected to the mobile computing device 350 through an expansion interface 372, which may include, for example, a SIMM (Single In Line Memory Module) card interface. The expansion memory 374 may provide extra storage space for the mobile computing device 350, or may also store applications or other information for the mobile computing device 350. Specifically, the expansion memory 374 may include instructions to carry out or supplement the processes described above, and may include secure information also. Thus, for example, the expansion memory 374 may be provided as a security module for the mobile computing device 350, and may be programmed with instructions that permit secure use of the mobile computing device 350. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 352), perform one or more methods, such as those described above. The instructions can also be stored by one or more storage devices, such as one or more computer- or machine-readable mediums (for example, the memory 364, the expansion memory 374, or memory on the processor 352). In some implementations, the instructions can be received in a propagated signal, for example, over the transceiver 368 or the external interface 362.

The mobile computing device 350 may communicate wirelessly through the communication interface 366, which may include digital signal processing circuitry where necessary. The communication interface 366 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 368 using a radio-frequency. In addition, short-range communication may occur, such as using a Bluetooth, WiFi, or other such transceiver (not shown). In addition, a GPS (Global Positioning System) receiver module 370 may provide additional navigation- and location-related wireless data to the mobile computing device 350, which may be used as appropriate by applications running on the mobile computing device 350.

The mobile computing device 350 may also communicate audibly using an audio codec 360, which may receive spoken information from a user and convert it to usable digital information. The audio codec 360 may likewise generate audible sound for a user, such as through a speaker, e.g., in a handset of the mobile computing device 350. Such sound may include sound from voice telephone calls, may include recorded sound (e.g., voice messages, music files, etc.) and may also include sound generated by applications operating on the mobile computing device 350.

The mobile computing device 350 may be implemented in a number of different forms, as shown in the figure. For example, it may be implemented as a cellular telephone 380. It may also be implemented as part of a smart-phone 382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A computer-implemented method comprising:
receiving, by a long-term evolution (LTE) base station, an instruction to communicate with a client device over a first frequency;
transmitting, by the LTE base station and to the client device over a second, different frequency, an instruction to communicate with the LTE base station over the first frequency after a particular period of time;
after the particular period of time has elapsed, receiving, by the LTE base station and from the client device over the first frequency, a request to establish a communication channel over the first frequency; and
establishing, by the LTE base station, a communication channel with the client device over the first frequency.

2. The method of claim 1, wherein transmitting, by the LTE base station and to the client device over a second, different frequency, an instruction to communicate with the LTE base station over the first frequency after a particular period of time comprises:
transmitting, by the LTE base station and to the client device over the second, different frequency, a radio resource control (RRC) release message that instructs the client device to disconnect from the LTE base station and the particular period of time after which the LTE base station will be available to establish a communication channel over the first frequency.

3. The method of claim 1, wherein transmitting, by the LTE base station and to the client device over a second, different frequency, an instruction to communicate with the LTE base station over the first frequency after a particular period of time comprises:
transmitting, by the LTE base station and to the client device over the second, different frequency, a system information block (SIB) message that includes the particular period of time after which the LTE base station will be available to establish a communication channel over the first frequency.

4. The method of claim 1, comprising:
receiving, by the LTE base station and from the client device over the second, different frequency, an RRC connection request,
wherein transmitting, by the LTE base station and to the client device over a second, different frequency, an instruction to communicate with the LTE base station over the first frequency after a particular period of time comprises:
transmitting, by the LTE base station and to the client device over the second, different frequency, an RRC connection reject message that indicates the particular period of time after which the LTE base station will be available to establish a communication channel over the first frequency.

5. The method of claim 1, wherein transmitting, by the LTE base station and to the client device over a second, different frequency, an instruction to communicate with the LTE base station over the first frequency after a particular period of time comprises:
transmitting, by the LTE base station and to the client device over the second, different frequency, an RRC connection reconfiguration message (i) that instructs the client device to establish a communication channel with a different LTE base station over the first frequency and (ii) that indicates the particular period of time after which the different LTE base station will be available to establish the communication channel over the first frequency.

6. The method of claim 5, wherein the RRC connection reconfiguration message indicates an additional particular time period after which the LTE base station will be available to establish a communication channel over the first frequency.

7. The method of claim 1, wherein transmitting, by the LTE base station and to the client device over a second, different frequency, an instruction to communicate with the LTE base station over the first frequency after a particular period of time comprises:
transmitting, by the LTE base station and to the client device over the second, different frequency, an RRC connection reconfiguration message (i) that indicates that the LTE base station will remove the client device from the second component carrier and (ii) that indicates the particular period of time after which the different LTE base station will be available to establish a secondary component channel over the first frequency.

8. The method of claim 1, wherein the client device establishes the communication channel with the LTE base station over the first frequency without attempting to establish the communication channel with the LTE base station over other frequencies.

9. The method of claim 1, comprising:
receiving, by the LTE base station, an instruction to cease communicating with the client device over the second, different frequency,
wherein transmitting, by the LTE base station and to the client device over a second, different frequency, an instruction to communicate with the LTE base station over the first frequency after a particular period of time comprises:
in response to receiving the instruction to cease communicating with the client device over the second, different frequency, transmitting the instruction to communicate with the LTE base station over the first frequency after the particular period of time.

10. The method of claim 1, wherein transmitting, by the LTE base station and to the client device over a second, different frequency, an instruction to communicate with the LTE base station over the first frequency after a particular period of time comprises:
in response to receiving the instruction to communicate with the client device over the first frequency, transmitting the instruction to communicate with the LTE base station over the first frequency after the particular period of time.

11. A system comprising:
one or more computers; and
one or more storage devices storing instructions that are operable, when executed by the one or more computers, to cause the one or more computers to perform operations comprising:
receiving, by a long-term evolution (LTE) base station, an instruction to communicate with a client device over a first frequency;
transmitting, by the LTE base station and to the client device over a second, different frequency, an instruction to communicate with the LTE base station over the first frequency after a particular period of time;
after the particular period of time has elapsed, receiving, by the LTE base station and from the client device over the first frequency, a request to establish a communication channel over the first frequency; and
establishing, by the LTE base station, a communication channel with the client device over the first frequency.

12. The system of claim 11, wherein transmitting, by the LTE base station and to the client device over a second, different frequency, an instruction to communicate with the LTE base station over the first frequency after a particular period of time comprises:
transmitting, by the LTE base station and to the client device over the second, different frequency, a radio resource control (RRC) release message that instructs the client device to disconnect from the LTE base station and the particular period of time after which the LTE base station will be available to establish a communication channel over the first frequency.

13. The system of claim 11, wherein transmitting, by the LTE base station and to the client device over a second, different frequency, an instruction to communicate with the LTE base station over the first frequency after a particular period of time comprises:
transmitting, by the LTE base station and to the client device over the second, different frequency, a system information block (SIB) message that includes the particular period of time after which the LTE base station will be available to establish a communication channel over the first frequency.

14. The system of claim 11, wherein the operations comprise:
receiving, by the LTE base station and from the client device over the second, different frequency, an RRC connection request,
wherein transmitting, by the LTE base station and to the client device over a second, different frequency, an instruction to communicate with the LTE base station over the first frequency after a particular period of time comprises:
transmitting, by the LTE base station and to the client device over the second, different frequency, an RRC connection reject message that indicates the particular period of time after which the LTE base station will be available to establish a communication channel over the first frequency.

15. The system of claim 11, wherein transmitting, by the LTE base station and to the client device over a second, different frequency, an instruction to communicate with the LTE base station over the first frequency after a particular period of time comprises:
transmitting, by the LTE base station and to the client device over the second, different frequency, an RRC connection reconfiguration message (i) that instructs the client device to establish a communication channel with a different LTE base station over the first frequency and (ii) that indicates the particular period of time after which the different LTE base station will be available to establish the communication channel over the first frequency.

16. The system of claim 11, wherein transmitting, by the LTE base station and to the client device over a second, different frequency, an instruction to communicate with the LTE base station over the first frequency after a particular period of time comprises:
transmitting, by the LTE base station and to the client device over the second, different frequency, an RRC connection reconfiguration message (i) that indicates that the LTE base station will remove the client device from the second component carrier and (ii) that indicates the particular period of time after which the different LTE base station will be available to establish a secondary component channel over the first frequency.

17. The system of claim 11, wherein the client device establishes the communication channel with the LTE base station over the first frequency without attempting to establish the communication channel with the LTE base station over other frequencies.

18. The system of claim 11, wherein the operations comprise:
receiving, by the LTE base station, an instruction to cease communicating with the client device over the second, different frequency,
wherein transmitting, by the LTE base station and to the client device over a second, different frequency, an instruction to communicate with the LTE base station over the first frequency after a particular period of time comprises:
in response to receiving the instruction to cease communicating with the client device over the second, different frequency, transmitting the instruction to communicate with the LTE base station over the first frequency after the particular period of time.

19. The system of claim 11, wherein transmitting, by the LTE base station and to the client device over a second, different frequency, an instruction to communicate with the LTE base station over the first frequency after a particular period of time comprises:
in response to receiving the instruction to communicate with the client device over the first frequency, transmitting the instruction to communicate with the LTE base station over the first frequency after the particular period of time.

20. A non-transitory computer-readable medium storing software comprising instructions executable by one or more computers which, upon such execution, cause the one or more computers to perform operations comprising:
receiving, by a long-term evolution (LTE) base station, an instruction to communicate with a client device over a first frequency;
transmitting, by the LTE base station and to the client device over a second, different frequency, an instruction to communicate with the LTE base station over the first frequency after a particular period of time;
after the particular period of time has elapsed, receiving, by the LTE base station and from the client device over the first frequency, a request to establish a communication channel over the first frequency; and
establishing, by the LTE base station, a communication channel with the client device over the first frequency.
